(19) United States
(12) Patent Application Publication
(10) Pub. No.: US 2008/0237119 A1
(43) Pub. Date: Oct. 2, 2008

(54) Liquid Delivery

(75) Inventor: Tuan Chi Ta, Sunbury-on-Thames Middlesex (GB)

Correspondence Address: MCKENNA LONG & ALDRIDGE LLP, 1900 K STREET, NW, WASHINGTON, DC, 20006, US

(73) Assignee: THAMES WATER UTILITIES LIMITED, Berkshire (GB)

(21) Appl. No.: 11/597,138

(22) PCT Filed: May 19, 2005
(86) PCT No.: PCT/GB2005/001974

§ 371 Date: Jan. 10, 2008

(30) Foreign Application Priority Data
May 20, 2004 (GB) 0411286.8

(51) Int. Cl. B01D 43/00

(52) U.S. Cl. 210/513

(57) ABSTRACT

The invention relates to a device (1), for delivering a liquid into a tank (which can be large, and of any desired footprint), comprising an inlet (2) for a liquid, an outlet (3) for liquid, and means (4) adapted to change flow direction of the liquid gradually towards the inlet (2). In the embodiment, the device (1), includes a single short cone (5) which is fed with incoming liquid from a conduit pipe, or manifold (6). The inlet (2) of the cone (5) is effectively formed by the means (2) to change flow direction which means (2) is in the form of a swept “T” member connected between the conduit, pipe or manifold (6) and the inlet (2) of the cone (5). The cone has angle (θ) and entry diameter (d), the swept T has a radius of curvature (R), and the main pipe (6) a diameter (D), height (H) and width (W). For multiple units, additional parameters are number of units, length between units and the height (C) of the cone (5). Multiple unit parameters are selected for particular throughput. The use of the swept “T” member (2) effectively distributes the liquid flow by bending and streamlining the flow, rather than by reducing energy, which would slow down the flow. This results in potential operating headloss in a tank of liquid or system in which the device is installed being significantly reduced.

The invention relates to a liquid delivery, particularly to a device for delivering liquid to a tank for treatment.

Liquid containing entrained particles are often required to be treated in a system in order to remove those particulates, for example in water/sewage treatment works.

In one such system counter current dissolved air flotation is used, in other words liquid containing particles to be removed is passed, in a suitable tank, in counter current relation to air in the form of bubbles which entrain the particles and carry them to the surface as scum, for removal.

The liquid passing through the air bubbles passes downwardly to a filter bed, and then out of the tank.

Thus the process is used to separate low density particles from the carrying liquid. In brief, liquid is fed to the tank and allowed to gravitate. Dissolved gas bubbles introduced at the low level travel upward and capture the suspended particles. The gas/particles become lighter and float to the surface.

For the process to work, the downward flow of the liquid and the upward flow of the gas bubbles must be uniform across the cross sectional area of the tank. Uniform distribution of the liquid is difficult to achieve mainly because of the high momentum of the liquid.

The inlet system is to be regarded as the surface inlet system because the liquid is to be distributed uniformly across a surface. As it is used for the flotation (upward flow) process, the system is directed upwardly towards the liquid top surface in the tank. This upward flow, however, must not affect the downward flow in the tank.

It is an object of the invention to seek to meet these requirements.

According to a first aspect of the invention there is provided a device for delivering a liquid into a tank, comprising an inlet for liquid, an outlet for liquid, and means adapted to change flow direction of the liquid gradually towards the inlet.

The means may comprise a curved member upstream of and in fluid connection with the inlet. This provides for a streamlined flow where in effect each part of the liquid flow is bent smoothly towards a number of notional exits.

The curved member may comprise a swept ‘T’ member. This is a particularly efficient construction particularly when the swept ‘T’ member may be in direct liquid connection with the inlet.

The device may comprise a cone which diverges from the inlet to the outlet. Thus the inlet diverges from the swept ‘T’ member.

The cone may be connected to a conduit or manifold for delivering liquid to the tank via the swept ‘T’ member. Thus in a preferred construction, the swept ‘T’ member may be added to the conduit or manifold as an entry to the cone.

The cone may be relatively short. This results from the flow being distributed uniformly in the cone by the swept ‘T’ member.

According to a second aspect of the invention there is provided a system for separating particles entrained in a liquid in a tank, comprising a device as hereinbefore defined.

There may be a plurality of devices, suitably two devices spaced apart along a common conduit or manifold for delivering liquid to the tank.

Devices according to the invention are hereinafter described, by way of example, with reference to the accompanying drawings.

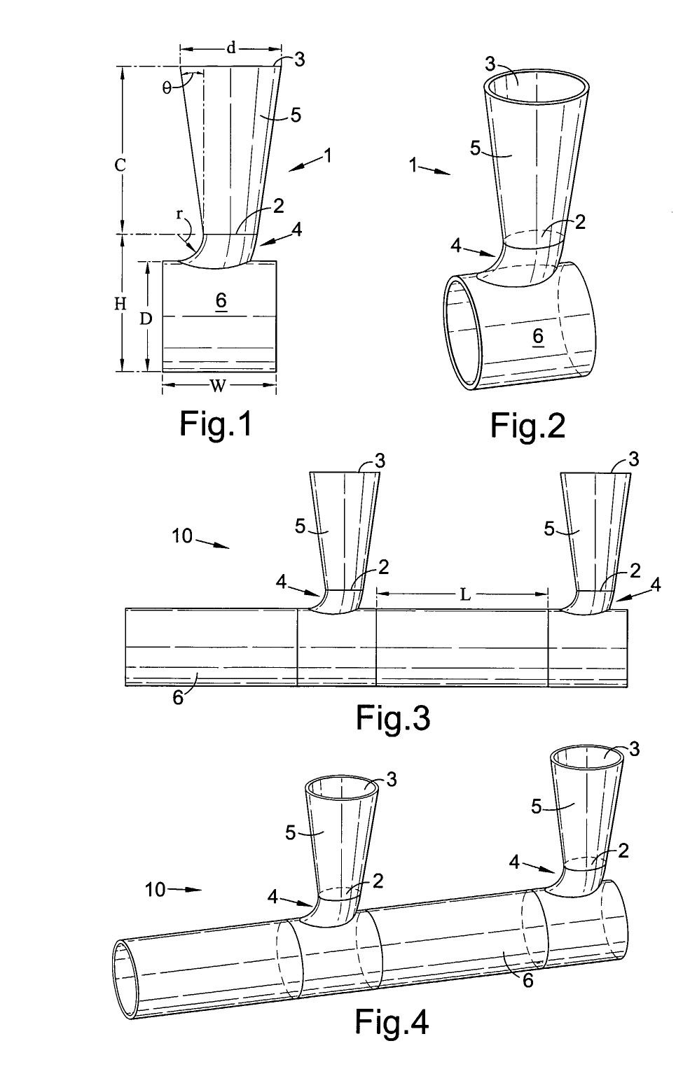

FIGS. 1 and 2 show schematically a side elevational and isometric view of a first embodiment of device according to the invention; and

FIGS. 3 and 4 show views similar to FIGS. 1 and 2, of a second embodiment according to the invention.

Referring to the drawings, in which like parts are referred to by like reference numerals, there is shown a device 1, 10 for delivering a liquid into a tank (which can be large, and of any desired footprint), comprising an inlet 2 for a liquid, an outlet 3 for liquid, and means 4 adapted to change flow direction of the liquid gradually towards the inlet 2.

In the embodiment, the device 1, 10 includes a single short cone 5 (FIGS. 1, 2) or two spaced short cones 5 (FIGS. 3, 4), the or each of which is fed with incoming liquid from a conduit pipe, or manifold 6. The inlet 2 of the or each cone 5 is effectively formed by the means 2 to change flow direction which means 2 is in the form of a swept ‘T’ member connected between the conduit, pipe or manifold 6 and the inlet 2 of the cone 5.

In each case, the cone has angle (θ)and entry diameter (d), the swept T has a radius of curvature (R), main pipe diameter (D) and height (H) and width (W) of T. For multiple units, additional parameters are number of units (n), length (L) between units and the height of the cone (C). Multiple unit parameters are selected for particular throughput.

With the swept T, the liquid flow is distributed uniformly in the cone. This allows a short cone to be used and the system can be operated at high flow.

The use of the swept ‘T’ member 2 effectively distributes the liquid flow by bending and streamlining the flow, rather than by reducing energy, which would slow down the flow. This results in potential operating headloss in a tank of liquid or system in which the device is installed being significantly reduced.

Moreover, the inlet system generates low turbulence and low shear in the liquid. This avoids the break of flocs when coagulant is added to aid the flotation process.

Further, the liquid is delivered upwardly, uniformly across the surface from the conduit, pipe or manifold via the cone 5 without disturbing surrounding downward flow of liquid by turbulence or vortices. This is because the flow in a single main in a tank must be fed upward. The natural expansion angle of a jet of liquid in liquid sets an angle limit to any device, which aims to smoothly diverge flow. As the liquid jets upwards, vortices form around the jet. In order to remove these vortices, solid wall is introduced around the jet. The device is therefore a cone 5 starting from the main pipe.

The liquid is directed gradually by the swept ‘T’ member. In effect, the streamline from each part of the flow stream is bent smoothly toward a number of exits. Turbulence is reduced to a minimum and there is no additional headloss.

1. A device for delivering a liquid into a tank, comprising an inlet for liquid, an outlet for liquid, and means adapted to change flow direction of the liquid gradually towards the inlet.

2. A device according to claim 1, the means comprising a curved member upstream of and in fluid connection with the inlet.

3. A device according to claim 2, the curved member comprising a swept ‘T’ member.

4. A device according to claim 3, the swept ‘T’ member being in direct liquid connection with the inlet.

5. A device according to claim 1, the device comprising a cone which diverges from the inlet to the outlet.

6. A device according to claim 3, the cone being connected to a conduit or manifold for delivery liquid to the tank via the swept ‘T’.

7. A device according to claim 1, the cone being relatively short.

8. A system for separating particles entrained in a liquid in a tank, comprising a device according to claim 1.

9. A system according to claim 8, there being a plurality of devices according to any preceding claim.

10. A system according to claim 9, there being two devices spaced apart along a common conduit or manifold for delivering liquid to the tank.
